(19) United States
(12) Patent Application Publication
(10) Pub. No.: US 2016/0107369 A1
(43) Pub. Date: Apr. 21, 2016

(54) METHOD FOR MANUFACTURING A FILAMENT-WOUND STRUCTURE AND USE THEREOF

(71) Applicant: FALCK SCHMIDT DEFENCE SYSTEMS A/S, Odense C (DK)

(72) Inventor: Damir Ljubicic, Odense S (DK)

(73) Assignee: FALCK SCHMIDT DEFENCE SYSTEMS A/S, Odense C (DK)

(21) Appl. No.: 14/893,709

(22) PCT Filed: May 27, 2014
(86) PCT No.: PCT/DK2014/050144

§ 371 Date: Nov. 24, 2015

(30) Foreign Application Priority Data
May 27, 2013 (DK) PA 2013 70288

(51) Int. Cl. B29C 53/58; B29C 53/62; B29C 33/00; B29C 70/32

(52) U.S. Cl. CPC B29C 53/587; B29C 70/32; B29C 53/62; B29C 33/0033; B29K 2105/10

(57) ABSTRACT

There is described a method for manufacturing a filament-wound hollow body. The method comprises providing a mandrel (2) rotatable about an axle (4); during rotation of the mandrel (2), winding filaments around an outer side of the mandrel (2) in combination with a hardening resin for providing a solid laminate (1) of the filaments after hardening of the resin. At least one hole is provided in the laminate by filament-winding a laminate (1A) onto the mandrel (2); then, before hardening of the first laminate (1A), providing a hole in the laminate by pushing filaments aside from a point location in first laminate (1A) to form the hole without breaking the filaments

The laminate can be dimensioned for use as part of a vehicle or an aircraft.

### BACKGROUND OF THE INVENTION

1. Field of the Invention

The present invention relates to a method for manufacturing a filament-wound solid laminate structure, for example a vehicle body, where filaments are wound onto a mandrel and solidified in a resin to faun the solid structure. It relates to methods of how to provide mounting holes, especially as anchoring points for mechanical parts, in such structures. It also relates to use of such structures.

2. Description of Related Art

In order to provide light-weight structure with high mechanical stability, various methods are available. International patent application WO96/22878 by Forster et al. assigned to Sikorsky Aircraft Corporation discloses with reference to earlier prior art in the introduction a honeycomb structure as a core, onto which a composite skin layer is provided in a vacuum moulding process in order to provide a product with increased stability. As a skin layer, a fibre reinforced matrix laminate is used, for example graphite, aramid, or fibreglass fibres disposed in a binding matrix, such as epoxy or phenolic resinous material. This skin layer is then glued with a film adhesive to the honeycomb structure under vacuum conditions in order to provide a close contact. In order to prevent distortion of the honeycomb structure by movement of the skin layer during the moulding process, the skin layer is fixed by protruding pins disposed on a rigid mould member in a peripheral portion of the moulding assembly in adjacent relation to the honeycomb composite article that is to be formed. The teaching of the document is to avoid such pins, as these are a source of high maintenance due to periodic cleaning and because they are a hazard to the operator. Instead, an adhesive sealer strip and a restraining edge are disclosed for keeping the skin in place. The adhesive strip and the restraining edge are also provided in a peripheral portion of the moulding assembly in adjacent relation to the honeycomb composite article to be formed. The peripheral portion is trimmed and removed from the final honeycomb product.

As these pins are provided in a peripheral portion of the moulding assembly in adjacent relation to the honeycomb composite article to be formed, they do not form part of the article, and the holes created by the pins are not part of the article either, as the final article is a honeycomb structure with an intact skin layer without holes. The disclosure teaches explicitly that the peripheral portion used for restraining the skin layer are trimmed and removed. The teaching of the document is to avoid such pins during manufacture, as these are a source of high maintenance due to periodic cleaning and because they are a hazard to the operator.

More flexible processes for providing light-weight structures without vacuum forming include winding of filaments or strips onto a mandrel together with a resin and, then, hardening the combination of resin and filaments to provide a rigid structure. In some cases, the structure is removed from the mandrel, whereas in other cases, the mandrel is used as an integrated part of the wound structure.

An example of a method for manufacturing a vehicle by filament winding onto a mandrel is disclosed in International patent application WO2008/064676 by Falck-Schmidt. The wound structure is used as a body for military vehicles or aircrafts. In order to mount motor, gearbox, wheel suspension and other equipment onto the body, aluminium mounts may be placed on the mandrel at the areas where the equipment is to be mounted. These mounts are integrated into the body during the winding process. Subsequently, through-holes are established in order to provide access to the mounts, and the areas are cleaned from fibres. The body may subsequently be coated with paint. Finally wheel suspension, motor, gearbox is mounted to the incorporated mounts.

British patent application GB2028708 discloses a vehicle body shell produced by winding continuous resin-saturated glass fibre filaments onto a former that rotates on a mandrel. After curing, apertures for doors and windows are cut out. Metal plates or fittings can be incorporated to provide strong areas, such as engine mountings or jacket points. These would be pre-drilled as necessary and placed releasable on the former and covered by the winding. After winding and curing, the former is removed, and the metal plates or fitting are retained on the wound body shell due to bonding to the wound shell. The blocked, predrilled holes are cleared by drilling through from inside the shell.

When having to clear holes for mounting, as in the above mentioned WO2008/064676 and GB2028708, there is a disadvantage of additional work for creating the through-holes. Further, the provision of through-holes damages filaments in the laminate and results in reduced strength of the body in the region of the through-holes, which is a further disadvantage. Especially, in connection with military vehicles, high strength in light weight structures is highly requested.

U.S. patent application No. 2006/0054742 corresponds to U.S. Pat. No. 7,261,786 B2 by Druckmann discloses a filament-wound mobile platform personnel berth unit, especially a crew rest berth in aircrafts, trains, or ships. Connecting fittings are included in the wound unit by overlapping a portion of the fittings between layers of filament windings. The fittings extend from the body out of the surface of the body as an anchoring structure. Such anchoring structure is well suitable for lifting the structure or for fastening the structure to a support, however, the disclosed fittings seem not useful for vehicles to which wheel suspension, motor or gearbox is mounted.

JPH 05269868 discloses a method of manufacturing a filament-wound composite structure. A bundle of fibres impregnated with resin is wound around a mandrel having detachable or sinkable pins provided in its surface at predetermined positions. After moulding and curing, the pins are detached from the mandrel or sunk into the mandrel. A tube having bolt holes are hereby obtained without the need of removing material and thereby breaking the fibres by for example drilling. The pins attached to the mandrel have various shapes according to uses but the leading end of each of the pins is formed into a shape prevented from hooking onto the filaments during winding, for example, a semi-spherical shape. In automated winding machines the fibres are under tension when winding. Due to the tension some of the fibres will break as they meet the pin and slide along the surface of the pin to a resting position on the mandrel. Moreover, the pins in JPH 05269868 act as an obstruction for the fibres during winding and they introduce randomness in relation to the number of filaments on each side of the pin. Therefore it is difficult to control the laminate with precision in the vicinity of the holes. The properties of the laminate may vary around the holes, thus requiring the design safety factor to increase in order to be sure that the desired strength of the finished product is achieved.

U.S. Pat. No. 3,021,241 discloses a method for manufacturing a filament-wound hollow body. The method comprising the steps of providing a mandrel rotatable about an axle; during rotation of the mandrel, winding filaments around an outer side of the mandrel in combination with a hardening resin for providing a laminate and providing a number of pins with tapering tips on the mandrel, filament-winding the laminate so that the filaments slide off the tapering tips and settle around the pins.

It would be desirable to provide mounting means in filament-wound structures that reduce manpower during production relatively to the above-mentioned methods and where filaments are not damaged, such that optimal stability is retained.

### SUMMARY OF THE INVENTION

It is therefore the objective of the invention to provide an improvement in the art and to avoid the mentioned disadvantages. Specifically, it is an objective to include anchoring means, for example holes with or without screw threads, in filament-wound structures, for example vehicle bodies, without the necessity of breaking filaments, and at reduced work load.

This is achieved by a method for manufacturing a filament-wound hollow body according to the following.

According to the method, a mould form is provided rotatable about an axle. In accordance with terminology in the art, this form is in the following generally called mandrel, irrespectively of the fact that, in some cases, the term mandrel is used for the rotating axle only. During rotation of the mandrel, filaments are wound in multiple layers around an outer side of the mandrel. As the filaments prior to winding, during winding, and/or after winding are combined with a hardening resin, hardening of the resin results in a solidly shaped composite laminate. The method concerns as an initial step the problem of how to provide at least one proper hole in the laminate without the disadvantages as discussed above.

In a first embodiment, the method comprises filament-winding a first laminate onto the mandrel. Then, before hardening, typically in a wet state just after filament-winding the first laminate, a hole is provided in the first laminate by pushing filaments aside from a point location in the first laminate to form the hole without breaking the filaments. For example, a pin member with a tapering tip, especially if the tapering tip is a sharp spike, is driven through the first laminate and thereby pushes aside the filaments before hardening. As an alternative, a needle shaped tool is driven through the laminate and moved sideways to provide the hole.

Thus the present invention differs from the technology disclosed in U.S. Pat. No. 3,021,241 and makes it possible to provide a more flexible arrangement of holes in the laminate and reduces the risk of breaking the filaments.

Such holes may be used as anchoring points for mounting mechanical parts, why the hole should have a diameter of at least 4 mm, for example at least 8 mm, or at least 16 mm, which leaves space to anchor suitable bolts or other mechanical fasteners. For the same reason, the holes are advantageously provided with screw threads.

In said embodiment, a hole is provided in the laminate while the laminate is not yet hardened and without breaking the filaments.

In the first embodiment, where the laminate is penetrated, pushing the filaments aside to the rim of the hole increases the density of the filaments at the edge of the hole and in the near vicinity around the hole and thereby increases the stability of the hole at its rim. This is in contrast to prior art methods of drilling holes, where part of the filaments are removed, and filaments are also broken, which in turn reduces the stability of the region around holes.

The method increases the stability of holes by increasing the density of filaments around the hole and without breaking the filaments.

The first method can be combined with a second method wherein a pin member is provided on the mandrel, the pin member having a base and a tapering tip in extension of the base, the tapering tip pointing away from the outer side of the mandrel where the laminate is to be provided. A laminate is then filament-wound onto the mandrel. Due to the tapering tip, the filaments slide off the tapering tip and settle around the base of the pin member, by which the filaments make up a rim of the hole when the pin member is removed from the hole, typically after hardening of the laminate. In the second method, the sliding off the tapering tip results in the filaments being concentrated around the rim of the hole that is being provided once the pin member is removed.

The combined methods provides a strengthened laminate, where the first embodiment is used to provide a first laminate on the mandrel and the second method is used to provide a second laminate on top of the first laminate. In this embodiment, where the two methods are combined, the hardening of the first laminate can be done before the filament winding of the second laminate on top of the first laminate, or the hardening can be done together with the second laminate. Also possible is an intermediate partial hardening of the first laminate before filament-winding of the second laminate on top of the first laminate. For example, the first laminate is allowed to partly solidify before the second laminate is wound on top of the first laminate, but the final curing is done after the second filament winding. Hardening with curing at elevated temperatures can optionally imply not only a solidification of the laminates but also a partial or entire polymerization of the resin.

The method for manufacturing has the primary advantage of providing light weight structures with a high mechanical stability. Especially, in military vehicles and aircraft, light weight structures are highly desired without compromising sufficient mechanical stability. For this reason, manufacturing methods for military vehicles and aircraft are steadily improved with respect to these parameters. Also, the explained method for manufacturing provides not only high degree of flexibility in design but also high flexibility in post-production completion, where various mechanical parts and accessories are anchored to the structure. For military vehicles, the anchoring points may, optionally, be used for fastening
mechanical parts of the vehicle itself, for example wheel suspensions,
armouring equipment, including collision-damping materials, such as air, liquid and ceramics,
accessories, for example weapons, containers, support carriers, or camouflage equipment.

It is pointed out that the list is not exhaustive.

The fact that the holes provided in the laminate of the final product can be used as anchoring points to which mechanical items are fastened is in contrast to the pierced holes as described in International patent application WO96/22878 by Forster, where the piercing pins and the holes are provided in a peripheral portion of the moulding assembly and where the peripheral portion is trimmed away in order not to be part of the final product.

Typically, the filaments, for example glass, carbon, aramid filaments, are wound around a mould form, typically called a mandrel. By an automated procedure, fibrous material is provided from cylindrical spools and wound around the mandrel after soaking the fibres in a resin bath. Alternatively, resin is sprayed onto the filaments as the material is wound. For example, the resin is epoxy resin or a polyester resin. After the Winding process, the resin-covered composite is cured through heating.

In a concrete embodiment, the pin member has a tapering tip, for example with a sharp spike or a blunt tip, on a base that is not tapering, for example on a cylindrical base. The base is optionally provided with gripping means for gripping the pin member for screwing.

In some embodiments, the method further comprises, pushing filaments aside from a point location in first laminate to form the hole without breaking the filaments. This hole is then covered by a pin member with a tapering tip on a base, the tapering tip extending laterally away from the first laminate. While the tapering tip of the pin member covers the hole in the first filament, a second laminate is wound onto the first filament. Due to the inclined shape of the tapering tip, the filaments slide off the tapering tip during winding and settle around the hole, for example around the base of the pin member. After the winding, the pin member is removed for uncovering the hole in the final laminate, typically after hardening of the resin.

For example, such pin member is also used for pushing the filament aside first. In one practical embodiment, the pin member is pushed with the tapering tip through the first laminate from the mandrel-side of the first laminate until the tapering tip has penetrated the first laminate and the base of the pin member fills the hole in the first laminate.

The pushing aside of the filaments in the first laminate to form the hole result in a higher density of unbroken filaments around the hole, which is increasing the strength of the hole.

A hole in the laminate, provided as described above, can be used for mounting purposes, for example by providing a bolt through the laminate from one side and fastening it by a nut from the opposite side. In order to increase the strength, annular discs or other types of enforcement element may be used on both sides of the laminate to increase the strength of the laminate around the hole. The bolt/nut combination is only one of many fastening possibilities for the skilled person, and other fastening means can be applied alternatively in combination with the hole, for example including rivets or dowels.

Alternatively, for increasing the strength, the following methods may be applied. In these embodiments, at least one bushing is provided in the hole of the laminate, advantageously for fastening purposes. The bushing may serve to accommodate fastening elements, for example bolt/nut combinations, which are extending through the bushing and, thus, extending through the laminate, Optionally, the bushing itself may comprise an inner threading for receiving a bolt. The latter has the advantage of eased one-sided mounting.

In some of these embodiments, the method comprises filament-winding a first laminate onto the mandrel and then, before hardening of the first laminate, providing a hole in the laminate by pushing filaments aside from a point location in first laminate to form the hole. This step has already been discussed above. Further, a plate member is provided, the plate member comprising a plate and a sleeve member, the sleeve member having an internal bushing. This sleeve member is rigidly fastened to the plate in lateral extension of an opening in the plate, such that the opening in the plate gives access to the bushing. If the bushing has an internal threading to constitute a screw hole, the opening in the plate gives access to this screw hole. The plate is positioned parallel to and in contact with a surface of the first laminate and with the sleeve member extending through the hole in the first laminate. Further, a pin member is provided, covering the opening and having a tapering tip extending laterally away from the opening on the opposite side of the plate relatively to the sleeve member. With the pin member extending from the first laminate, a second laminate is wound onto the first laminate with the filaments sliding off the tapering tip and settling around the hole, for example around a base of the pin member. This step has also been discussed above. However, as the plate has been provided on the first laminate before the second filament-winding process, the plate is now sandwiched between the first and the second laminate. After finishing of the filament-winding, the pin member is removed in order to uncover the opening of the plate and the hole in the combined laminate and thereby providing access to the bushing, for example the screw hole in the bushing in case that the bushing comprises an internal threading.

In some cases, the mandrel is removed from the laminate after manufacture thereof. In other cases, the mandrel is retained as part of the final product such that mandrel and laminate remain in combination. In this case, the material of the mandrel can be used as further means for increasing the mechanical strength of the region around the hole in the laminate. Examples are given in the following.

The mandrel on which the laminate is provided has an inner surface on the opposite side relatively to the first laminate. In order to use the material of the mandrel for increasing the strength of the hole in the laminate, the hole in the first laminate is provided on top of a hole in the mandrel. Further, a mechanical counterpart, such as a bolt/nut combination as explained further in the following, is provided such that it extends to the inner side of the mandrel, supports against the inner side of the mandrel, and is fastened to the sleeve member, which, as explained above, extends through the first laminate. Thereby, the sleeve member can be tightened by the counterpart against the inner side of the mandrel and simultaneously, the plate that is fastened to the sleeve member is also tightening against the first laminate. In other words, the mandrel material with the laminate is sandwiched between the plate and the counterpart. By tightening the counterpart against the inner side of the mandrel, the plate is pressed against the outer side of the first laminate, assuring a tight configuration. Once, a second laminate is filament-wound onto the first laminate and hardened, the plate is tightly sandwiched between the first and the second filament layers, whereby the mechanical strength is further increased in the regions around the hole, because the embedded plate is providing additional mechanical strength around the hole in the laminate. As the material of the mandrel is incorporated in the final structure and not removed, the first laminate is sandwiched between the plate and the mandrel, and the plate and the mandrel yield a rigid support for the bushing through the laminate, useful for mounting mechanical parts to the bushing. As already mentioned, a threading in the bushing can be provided and used to assist ease of mounting by bolts.

In some practical embodiments, the sleeve member is provided with an outer threading, and the counterpart is provided with an inner threading matching the outer threading of the sleeve member. The sleeve member and the counterpart are screwed relatively to each other, by which the plate is tightened against the first laminate. The later is achieved by the counterpart supporting against the inner side of the mandrel such that a tightening thereof pulls the plate towards the laminated side of the mandrel.

In the following, a method is explained on how to use the pin member for penetrating the first laminate to create a hole in the first laminate; then mounting a plate member on top of the first laminate; and then mount the pin member on top of the plate member to protect the hole in the plate member from being covered with filaments during a second filament-winding process.

In such a further embodiment, the counterpart has a cross section corresponding to a cross section of the pin member. For example, in case that the counterpart comprises a bolt and a nut arrangement, the bolt has an outer cross section corresponding to the cross section of the base of the pin member. Further, the pin member is fastened to the counterpart, for example a bolt, such that the cross section is maintained in a transition from the base of the pin member to the counterpart, for example a bolt. By this arrangement of the pin member being in longitudinal extension of the counterpart, for example the bolt, the first laminate is penetrated by the pin member in order to create a hole large enough for the counterpart, for example a bolt, to also fit through the hole without damaging the filaments. Therefore, after forming the hole in the first laminate by the pin member, the pin member is pushed further through the created hole and the counterpart in extension of the pin member is also pushed partly through the hole; this is done without breaking filaments and facilitated due to the counterpart, for example bolt, having the same cross section as the pin member, especially the same cross section as the base of the pin member. As next steps, a plate member is inserted between the counterpart, for example the bolt, and the pin member. For this latter procedure, the pin member is removed from the counterpart while the counterpart resides in the hole of the first laminate, for example by screwing the pin member off the counterpart. Subsequently, the plate member is mounted onto the counterpart instead, for example screwed onto the counterpart, the counterpart extends through the hole from the mandrel side of the first laminate and through the first laminate and to the outer side of the first laminate. Effectively, this intermediate procedure is simply a swapping of the pin member with the plate member. Finally, the pin member is mounted onto the plate member, such that the counterpart, the plate member, and the pin member are in extension of each other. The plate of the plate member is then brought into close contact with the first laminate before the filament-winding of the second laminate by which the plate is sandwiched between the two laminate layers.

The method as described above is general, and a large variety of products can be produced this way. Special attention in this respect has a use of the method for manufacturing of vehicle parts or parts for aircraft. Possible parts include body part for vehicles or aircraft, for example front parts or back parts for the body or the main part of the body. Especially, for military vehicles that are produced in light-weight modules, the method is useful. For example front part or a rear part or a central body can be produced as described above. Optionally, the anchoring points can be used for assembling various modular body parts of the vehicle or aircraft. Modular configurations of military vehicles and aircraft have the advantage of high flexibility with respect to design of vehicles.

For this reason, in some embodiments, the method comprises dimensioning the laminate for use as part of a vehicle or an aircraft; providing multiple holes, such as bushings or screw holes, in the laminate and dimensioning the size and stability of the screw holes in the laminate with sufficient strength to stably support accessories, for example containers, weapons and/or armouring equipment, and/or mechanical parts, for example, wheel suspensions or even engine and gearboxes. The holes can also be used to mount the laminate structure to other laminate structures or to mount the laminate structure to other body parts of a vehicle or aircraft.

For example, the holes in the laminate, for example the bushings with or without internal threading, can be used for fastening armouring materials that are protective against projectiles and against fragments of explosives. If the bushings have internal threading to provide screw holes, the fastening can conveniently be done with bolts in the screw holes. In order to provide safety against gas attack, bolts with sealing, such as rubber washers, may be used, and empty holes in the laminate may be closed with plugs, for example plugged with bolts having gas tight sealing or by being made of a sealing material, such as rubber or other resilient polymer.

The mandrel can have various shapes, for example tubular with open ends or tubular with one or two closed ends. For example, the mandrel is a hollow skeleton having an inner side and an outer side that are similar in shape and of similar shape as the final laminate. Advantageously for vehicles and aircrafts, the inner side defines a hollow space that is unobstructed by the mandrel. Optionally, the hollow skeleton is made up by plates and brackets. For example, the mandrel is a hollow, cylindrical tube which has similar cylindrical shapes on the inside and on the outside, and the wound laminate would also have such cylindrical shape. A possible alternative is a hollow, conical shape tapering towards a closed end. Optionally, the cross section of the cylindrical or conical shape is rounded, for example circular or elliptical, or polygonal, for example square, rectangular, pentagonal or hexagonal, for example rhombic. The hollow shape is in contrast to the honeycomb structure that is disclosed in International patent application WO96/22878 by Forster. Thus, in most embodiments for the invention, the mandrel is free from a honeycomb structure. In some embodiments, the mandrel is provided as an assembly of flat profiles, the profiles being fastened to a common base plate. The flat profiles are bent into a polygonal frame, for example with hexagonal shapes, and decreasing in size so as to form a tapering polygonal mandrel when fastened to the base plate in consecutively decreasing order.

In order to increase the strength of the laminate, ceramics and/or aramid filaments can be incorporated in the laminate. The basic filament for the laminate typically comprise filaments made of glass, carbon and polymers, such as synthetic polymers, non-exhaustively including epoxy, polyester, polyimide, polyamide, polypropylene, polyethylene, polytetrafluorethylene (Teflon®).

The hardening of the laminate is typically done by heating, for example in an oven, for a predetermined period of time. The hardening process is often called curing.

The invention will now be explained below with reference to the accompanying schematic drawing, where:

### BRIEF DESCRIPTION OF THE DRAWINGS

FIG. 1 shows a mandrel with a filament wound laminate and the mandrel without laminate;

FIG. 2 shows en enlarged part of the mandrel;

FIG. 3 shows an exploded view of a screw system;

FIG. 4 a-k illustrates various steps in the manufacturing process with respect to the mounting and demounting of parts of the screw system.

### DETAILED DESCRIPTION OF THE INVENTION

In the following description, identical or corresponding elements in the various embodiments will be provided with the same designations below.

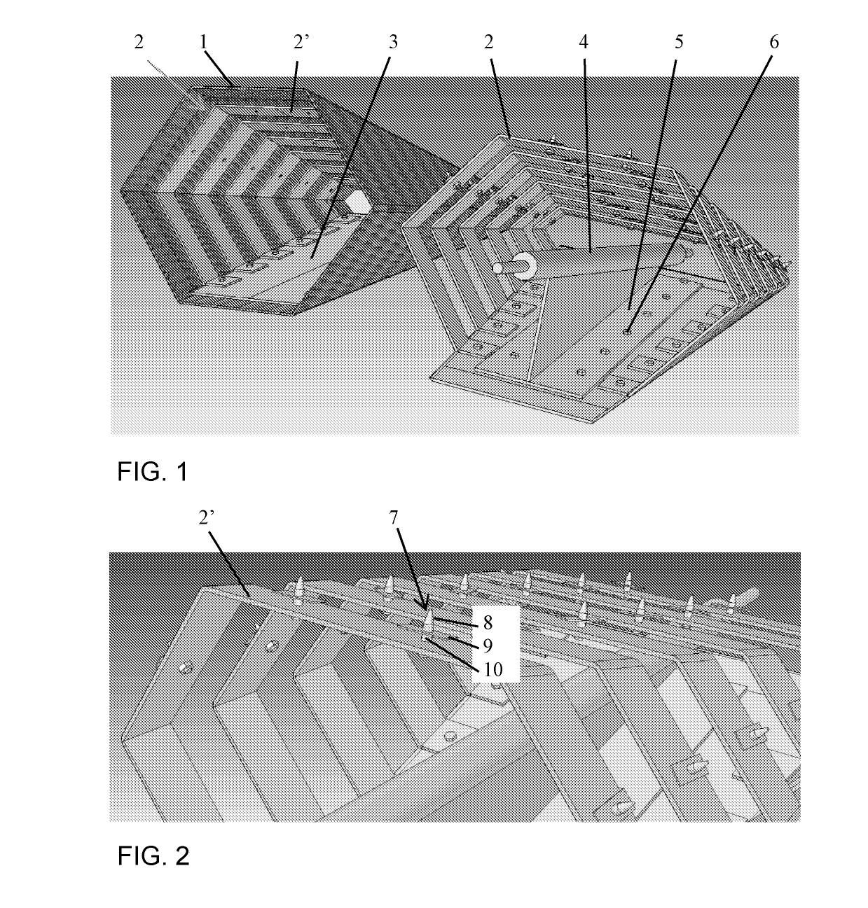

FIG. 1 illustrates in the left part of the image a filament wound laminate 1 on a forming mandrel 2. The mandrel 2 consists of a number of ribs 2′ of various sizes fastened to a support plate 3. In the right part of FIG. 1, the same mandrel 2 is shown without the laminate 1. Instead, the mandrel rotation axle 4 is illustrated, which is attached to a bracket 5 fastened with screws 6 to the support plate 3.

FIG. 2 shows an enlarged section of the mandrel 2. The ribs 2′ of the mandrel 2 are provided with holes through which a screw system 7 extends. The screw system 7 comprises a pin member 8 and a plate 9 for laminate anchorage. As will be explained in more detail below, the plate 9 will be embedded in the laminate such that the laminate is provided in the space 10 between the rib 2′ and the plate 9 and also on top of the plate 9, the laminate, however, not covering the pin member 8.

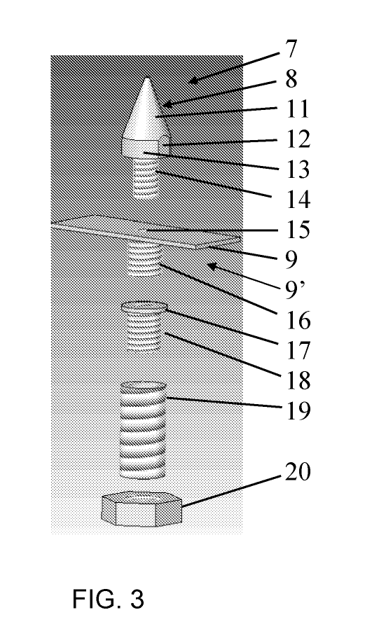

FIG. 3 illustrates the screw system 7. It comprises the pin member 8, a plate member 9′, an adapter bolt 18, a hollow adjustment bolt 19, and a nut 20. The pin member 8 has a conical top part 11 and a base 13 in extension of the conical top part 11, the base 13 being provided with parallel grip surfaces 12 for ease of turning the base 13 by a corresponding tool. Also, the pin member 8 comprises a threaded section 14 on the opposite side of the base 13 relatively to the top part 11. The plate member 9′ comprises a plate 9 that is combined with a sleeve member 16 having an internal threading, dimensioned for accommodating and cooperating with the threaded section 14 of the pin member 8, and an outer threading dimensioned to fit into an inner threading of the hollow adjustment bolt 19. The adjustment bolt 19 has an outer threading fitting to the inner threading of the nut 20. The screw system 7 also comprises an adapter bolt 18 with an inner threading corresponding to the outer threading of the pin member's threaded section 14 for accommodating the threaded section 14. The adapter bolt 18 has an outer threading matching with the inner threading of the hollow adjustment bolt 19 and has a collar 17 which works as an end stop when the adapter bolt 18 is screwed into the hollow adjustment bolt 19. In order to easily remove the adapter bolt 18 from the hollow adjustment bolt 19, the collar 17 may also be provided with grip surfaces, for example similar to the ones as shown for the base 13.

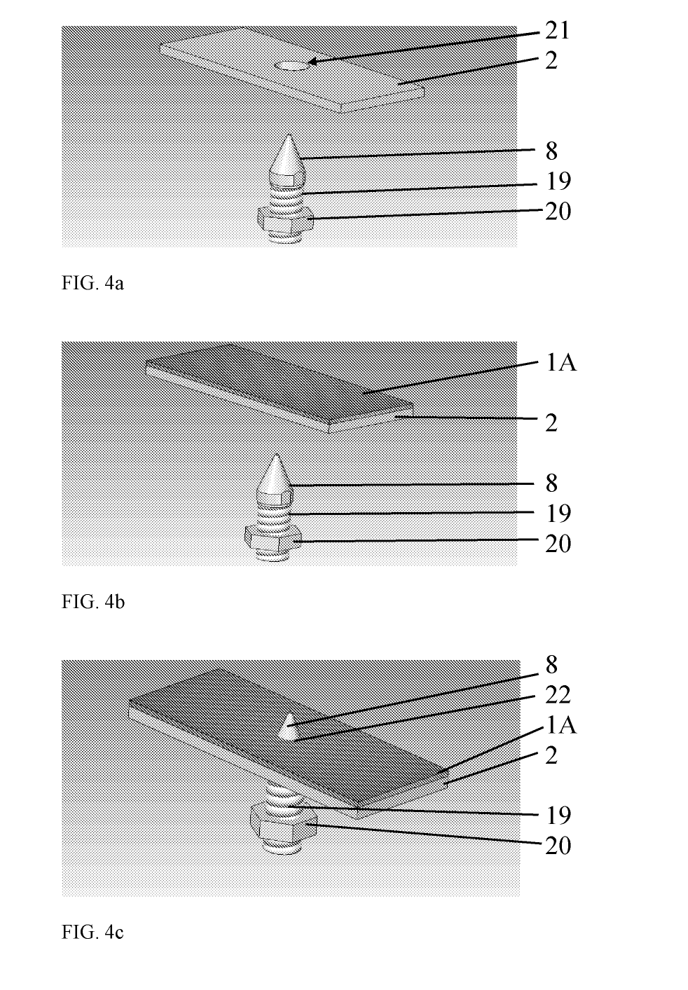

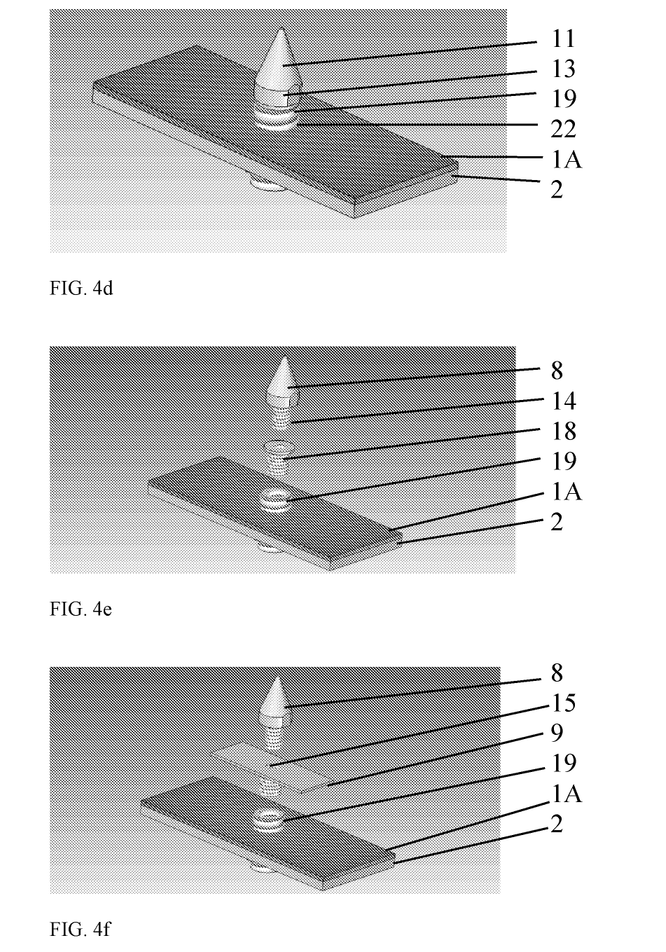

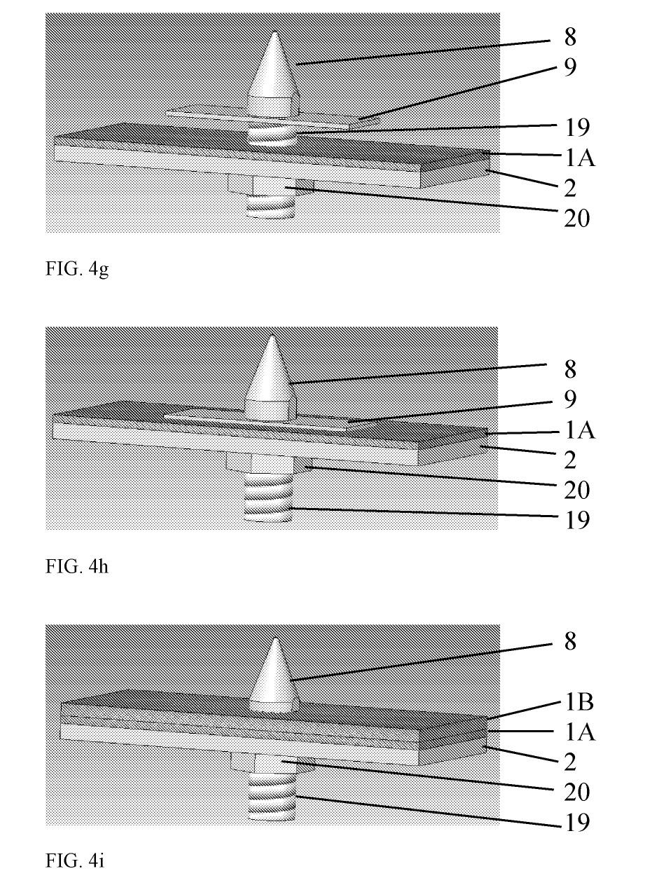

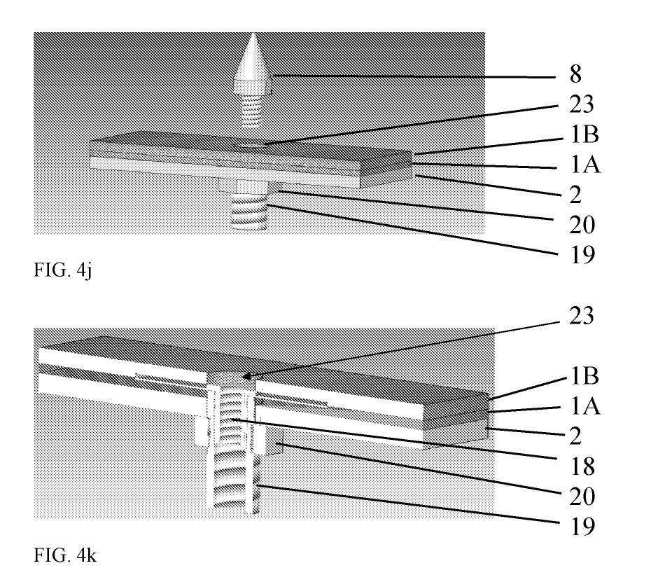

The screw assembly 7 is configured such that the pin member 8 can be screwed into the sleeve member 16, or into the adapter bolt 18. In turn, the sleeve member 16 of the plate member 9′ can be screwed into the hollow adjustment bolt 19, or the adapter bolt 18 can be screwed into the hollow adjustment bolt 19. The functioning of the various elements with respect to the sequence of steps for the manufacturing are explained in the following with reference to FIG. 4 a-k.

In FIG. 4a, the mandrel 2 is represented in the image by a small, artificially cut-out piece for sake of better illustration. It is to be understood however, that the small piece and the treatment thereof as explained in the following applies to the entire mandrel. As a first step, the mandrel 2 is covered by a first laminate 1A comprising multiple layers of filaments that are wound around the mandrel 2. With reference to FIGS. 1 and 2, the first filaments of the laminate would typically be at 45 degrees with the ribs 2′. The mandrel 2 is then covered with filaments wound in different directions over the mandrel, for example by a method as described in International patent application WO2008/064676 by Falck-Schmidt. The direction of the winding is used in order to achieve a predetermined preferred distribution of directional strength of the laminate.

Coming back to FIG. 4a, the mandrel 2 comprise through-holes 21 dimensioned to accommodate pin member 8. Once covered with filaments to provide the first laminate 1A, also the through-hole 21 is covered, as illustrated in FIG. 4b. At this stage in the production process, the pin member 8 is pressed through the first laminate 1A, as illustrated in FIG. 4c, while the first laminate 1A has not yet hardened; typically, the pin member 8 is pushed the first laminate 1A just after winding in a wet state. As the pin member 8 has a conical top part 11, filaments in the first laminate 1A are pressed apart without being broken to give way for the pin member 8. As the conical part 11 advanced through the first laminate 1A, the filaments are pressed further apart, until the entire top part 11 and the base 13 extend through the first laminate 1A. As shown in FIG. 4d, also part of the hollow adjustment bolt 19 extends through the first laminate 1A. Due to the pushing of the filaments from the centre of the though-hole to the rim of the through-hole 21 by the pin member 8, the first laminate 1A has a higher density of filaments at the edge of the pin, and therefore also at the edge of the through-hole 23. After curing and hardening of the first laminate 1A, this results in increased strength of the region around the through-hole 23.

In case that the first laminate 1A is covered with a second filament-wound laminate 1B, hardening of the first laminate 1A can be intermediate before a further filament-winding of a second laminate 1B on top of the first laminate 1A or together with second laminate 1B, for example by curing at elevated temperatures. In the following the manufacturing of such double laminate is explained.

As a further step, the pin member 8 and the adapter bolt 18 are removed from the hollow adjustment bolt 19, as illustrated in FIG. 4e, and the adapter bolt 18, as illustrated in FIG. 4f, is replaced by the plate member 9′, which is a combination of the plate 9 with the sleeve member 16. The outer thread of the sleeve member 16 is screwed into the inner threading of the hollow adjustment bolt 19, and the threaded section 14 of the pin 18 is screwed through the hole 15 of the plate 9 and into the inner threading of the adapter bolt 18. The configuration after this assembly is illustrated in FIG. 4g. By tightening the nut 20 against the mandrel 2, the plate 9 is pressed against the first laminate 1A, as illustrates in FIG. 4h. This way, the hollow adjustment bolt 19 in combination with the nut 20 function as a counterpart for the plate member 9′, as the mandrel 2 and the first laminate 1A are sandwiched between the plate member 9′ and this counterpart 19, 20.

As a next step, the filament winding is continued, placing a second filament laminate 1B on top of the first laminate 1A, as illustrated in FIG. 4i, by which the plate 9 is embedded between the first laminate 1A and the second laminate 1B. While filaments are provided onto the mandrel 2, the filaments would also hit the conical top part 11 of the pin member 8. However, due to the inclination of the conical top 11, the filaments are sliding along the side of the pin member 8 until the filaments rest in the laminate around the pin member 8. This leads to a higher density of filaments in the second laminate 1B around the pin member 8 than in the remaining laminate remote from the hole 23, which increases the strength of the finally cured laminate in the region at the edge of the through-hole 23.

The pin member 8 is then removed from the screw system 7, leaving-a clean, threaded hole 23 in the laminate 1A, 1B without the necessity of cutting the laminate. Not only is the weakening of the laminate due to cutting and boring avoided, the specific manufacturing technique even increases the strength of the laminate around the threaded hole 23 due to the higher density of filaments in the region around the edge of the threaded hole 23.

The final laminate as illustrated is designed to remain in combination with the mandrel 2, although the mandrel axle 4 is removed. However, alternatively, the final laminate 1 may be removed from the mandrel 2. For this, the nuts 20 would have to be unscrewed, and the ribs 2′ of the mandrel 2 demounted from the laminate 1.

In an alternative method, with reference to FIGS. 4b and 4c, the pin member 8 is not pressed through the first laminate 1A but is mounted before winding the filaments for the first laminate 1A onto the mandrel 2. In this case, the filaments would hit the conical top part 11 of the pin member 8 and would slide along the inclined side of the pin member 8 in the same way as already explained with reference to FIGS. 4h and 4i in connection with the formation of the second laminate 1B.

In an alternative method, the first laminate 1A is provided on the mandrel 2, as illustrated in FIG. 4b. The plate 9 is provided with a first tapered pin member 8 on the one side, as illustrated in FIG. 4g, and with a second tapered pin member (not shown) on the opposite side of the plate 9 pointing towards the first laminate 1A. While the first laminate 1A is still not hardened, the second tapered pin member (not shown) is pressed through the first laminate 1A until the plate 9 rests on the first laminate 1A. This method, however, requires that the second tapered tip (not shown) is pressed through the first laminate 1A at a position, where the first laminate 1A is not resting on the mandrel or where there is provided a hole in the mandrel 2. Typically, this embodiment has less strength for fastening as compared to the above described embodiment where the nut is supported against the mandrel 2, and the plate 9 is resting against the first laminate 1A. In some circumstances, however, the strength of the final laminate alone would be sufficient, why this embodiment is useful in cases where the laminate is removed from the mandrel 2 after hardening.

The final laminate 1 can be used for various purposes. For example, the illustrated laminate 1 may be used for a vehicle, such as a military vehicle, or aircraft. Examples of such vehicles are given in International Patent Application WO2008/064676 by Falck-Schmidt. For example, the laminate body as illustrated in FIG. 1 is a front part or back part of a military vehicle. In this case, fittings would be provided for mounting the front part or the rear part to the remaining body of the vehicle; such fittings could be provided on the mandrel itself, if the mandrel is part of the front part or rear part, or screw holes are used for the fitting, or special fittings are included in the laminate. The method as described allows for great variations with respect to fittings and connectors, such as the threaded holes 23.

For military purposes, armoured shields can be fastened with screws to the bushings or threaded holes 23. Also mechanical components can be fastened to the threaded holes, such as wheel suspension, gearbox, and engine mountings, as well as support carrier, containers or weapons, including missiles and guns.

It is to be noted that the attached drawing only illustrates non-limiting embodiments of the invention. Other embodiments will be possible within the scope of the present invention.

1-13. (canceled)

14. A method for manufacturing a filament-wound hollow body, the method comprising: providing a mandrel rotatable about an axle; during rotation of the mandrel, winding filaments around an outer side of the mandrel in combination with a hardening resin for providing a solid laminate of the filaments after hardening of the resin; providing at least one hole in the laminate of the hollow body; filament winding a first laminate onto the mandrel; then, after the filament winding of the first laminate but before hardening of the first laminate, providing a hole in the laminate by pushing filaments aside from a point location in first laminate to form the hole without breaking the filaments.

15. The method according to claim 14, wherein, a pin member with a tapering tip is driven through the first laminate after filament winding of the first laminate to create the hole before hardening of the first laminate.

16. The method according to claim 14, wherein the mandrel comprises through-holes, each dimensioned for accommodating the pin member, wherein the filament winding of the first laminate comprises covering the through-holes by the first laminate, and then driving the pin members through through-holes and thereby pushing of the filaments from the centre of the though-hole to the rim of the through-hole by the pin member.

17. The method according to claim 14, wherein, the method further comprises after forming the hole in the first laminate, blocking the hole by a pin member with a tapering tip extending laterally away from the first laminate; filament-winding a second laminate onto the first filament with the filaments sliding off the tapering tip and settling around the pin member; then removing the pin member for uncovering the hole in the final laminate.

18. The method according to claim 14, comprising
providing a plate member, the plate member comprising a plate and a sleeve member, the sleeve member having an internal bushing; wherein the sleeve member is rigidly fastened to the plate in lateral extension of an opening in the plate; positioning the plate parallel to and in contact with a surface of the first laminate and with the sleeve member extending through the hole in the first laminate;
providing a pin member covering the opening of the plate and having a tapering tip extending laterally away from the opening on the opposite side of the plate relatively to the sleeve member;
filament-winding a second laminate onto the first filament with the filaments sliding off the tapering tip and settling around the pin member and sandwiching the plate between the first and second laminate layers;
after finishing of the filament-winding, removing the pin member and uncovering the opening of the plate and the hole in the first laminate and thereby providing access to the bushing in the sleeve member.

19. The method according to claim 18, wherein the bushing comprises a threaded screw hole for fastening of a bolt in the threaded screw hole.

20. The method according to claim 18, wherein the mandrel has an outer surface on which the first laminate is provided and an inner, opposite surface; wherein the method comprises, providing the hole in the first laminate on top of a hole in the mandrel; providing a counterpart supporting against the inner side of the mandrel; fastening the sleeve member of the plate member to the counterpart and thereby sandwiching the mandrel and the first laminate between the counterpart and the plate of the plate member; then, with support against the inner side of the mandrel, tightening the counterpart relatively to the sleeve member and thereby tightening the plate against the first laminate before filament-winding a second laminate onto the first laminate.

21. The method according to claim 20, wherein the sleeve member of the plate member is provided with an outer threading, and the counterpart is provided with an inner threading matching the outer threading of the sleeve member; screwing the sleeve member and the counterpart relatively to each other while the mandrel and the first laminate are sandwiched between the counterpart and the plate of the plate member; and thereby tightening the plate against the first laminate.

22. The method according to claim 21, wherein the counterpart has a cross section corresponding to a cross section of the pin member; wherein the method comprises fastening the pin member in elongate extension to the counterpart, penetrating the first laminate by the pin member and, after forming the hole in the first laminate, pushing part of the counterpart through the hole; then, while the counterpart extends partly through the hole, removing the pin member from the counterpart; mounting the plate member onto the counterpart and, then, mounting the pin member onto the plate member for having the counterpart, the plate member, and the pin member in extension of each other; and then, filament-winding a second laminate onto the first filament.

23. The method according to claim 14, wherein the mandrel is a hollow skeleton having an inner side and an outer side that are similar in shape and of similar shape as the final laminate, wherein the inner side defines a hollow space that is unobstructed by the mandrel.

24. The method according to claim 23, wherein the mandrel is provided as an assembly of flat profiles, the profiles being fastened to a common base plate; the flat profiles being bent into mutually similar polygonal shapes and decreasing in size so as to form a tapering polygonal mandrel when fastened to the base plate in consecutively decreasing order.

25. The method according to claim 14, wherein the method comprises dimensioning the laminate for use as part of a vehicle or an aircraft and including the filament-wound hollow body in a construction of a military vehicle or for part of a military aircraft.

26. The method according to claim 25, wherein the method comprises fastening armouring materials protective against projectiles or fragments from explosives to the laminate to the at least one hole in the laminate of the hollow body.

27. The method according to claim 25, wherein the wherein the method comprises fastening weapons, containers, camouflaging equipment or support carriers to the at least one hole.
